(19) United States
(12) Patent Application Publication
(10) Pub. No.: US 2025/0224504 A1
(43) Pub. Date: Jul. 10, 2025

(54) SYSTEMS AND METHODS FOR LOCALIZING ONE OR MORE OBJECTS WITHIN AN ENCLOSED ENVIRONMENT

(71) Applicant: NIO Technology (Anhui) Co., Ltd., Hefei (CN)

(72) Inventors: Cinna Soltanpur, San Francisco, CA (US); Bhagyashree Puranik, Goleta, CA (US); Emmanuel Saez, San Jose, CA (US)

(73) Assignee: NIO Technology (Anhui) Co., Ltd., Hefei (CN)

(21) Appl. No.: 18/404,090

(22) Filed: Jan. 4, 2024

(51) Int. Cl. G01S 13/50; G01S 13/04

(52) U.S. Cl. CPC G01S 13/505; G01S 13/04

(57) ABSTRACT

Systems and methods for localizing one or more objects within an enclosed environment, and for adjusting an environmental feature associated with the enclosed environment. One or more processors receive output from three or more radar modules based on reflected radar signals as detected by a plurality of antennas. The processor(s) generate a preprocessed data set for each of the p antennas. The movements of the one or more objects within the enclosed environment are localized. Seat occupancy may be determined based on the localized movements of the one or more objects. An environmental feature of the enclosed environment may be adjusted based on the localized movement. The enclosed environment may be a vehicle cabin, and wherein the localized movement is from occupants within the vehicle cabin, or a door being opened. The localization may be performed by a trained deep neural network in which the data sets are processed groupwise.

### TECHNICAL FIELD

The present disclosure is directed to systems and methods for localizing one or more objects within an enclosed environment. More specifically, but not exclusively, the methods disclosed herein are directed to adjusting one or more environmental features by localizing movement within the vehicle cabin using a system of radar modules and a trained deep neural network.

### BACKGROUND

Occupancy sensing has realized several benefits across varied industries. For example, occupancy sensing within a residential or commercial space may limit or otherwise optimize energy consumption. Another example is non-contact health monitoring of an occupant. Early means of occupancy sensing included passive infrared and ultrasonic sensors, which are associated with significant drawbacks such as insufficient capability to detect stationary objects. More recently, it has been shown that radar signals are feasible as an occupancy sensor. However, the sensors of such systems (e.g., frequency-modulated continuous wave or constant information radar sensors) may lose accuracy due to multi-path effect on the return path of the signals, and the presence of clutter. The multi-path effect may cause the radar system to observe interference artifacts as one or more objects. Therefore, there remains further need in the art for improved methods and systems for localizing one or more objects within an enclosed environment, for example, localizing occupants within a vehicle.

### SUMMARY

The present disclosure is directed to localizing movement within an enclosed environment, for example, a cabin of a vehicle. Exemplary implementations include localizing one or more objects within the enclosed environment, determining presence of the objects based on the localized movements, and, optionally, adjusting one or more environmental features based on the determination. In the context of occupants within a vehicle cabin, the localizing of the occupants not only requires determining whether an unknown number of occupants, if any, are within the cabin, but also where within the cabin each of the unknown number of occupants are situated. The combination of these complex variables results in technical challenges not achievable by existing systems and/or conventional algorithms for processing radar data. In particular, the present disclosure addresses challenges associated with significant multi-path effect and the presence of clutter within the vehicle cabin. The present disclosure overcomes these shortcomings by, in various implementations, training and deploying a deep neural network to process output from receivers of radar modules to localize the movement. The methods disclosed herein localize human gestures as well as subtle body movements, such as breathing, with accuracy and precision.

In various implementations, the radar modules may include an antenna, a receiver, and one or more processors. Each of the radar modules may include directional antennas oriented towards one or more intended locations within the vehicle cabin. The radar signals travel through the vehicle cabin and interact with objects in their path. After the signals encounter objects present within the vehicle cabin and get reflected back towards the radar module, the antenna collects the signals and provides them to the receiver of the radar module. The processor may extract information about the objects, including their distance, motion, and other characteristics.

Exemplary methods include determining whether and where one or more occupants are present within the vehicle cabin, and/or whether one or more of the doors of the vehicle is open. Outputs from the receivers are pre-processed. The pre-processing of the data may include generating range-Doppler plots indicating an intensity of the reflected signal at each range and velocity. The generated range-Doppler plots are provided to a detection module.

In various implementations, a neural network may process groupwise the preprocessed data to localize of movements. The trained deep neural network processes the range-Doppler plots groupwise to determine or categorize the vehicle condition or classifying the movement category by localizing where within the vehicle cabin movements happen. Location of the occupants and to classify the movements of the occupants may be classified based on movement categories (e.g., a micro-Doppler signature, gross movements, etc.).

Therefore, according to a first aspect of the present disclosure, a method of localizing one or more objects within an enclosed environment is provided. Output from receivers of the radar modules is received. The output is based on reflected radar signals within the enclosed environment as detected by the antennas. The processor(s) generate a preprocessed data set for each of the antennas. Movement(s) of the one or more objects within the enclosed environment is localized based on the preprocessed data sets. Occupancy of the one or more objects at the different positions is determined based on the localized movements within the enclosed environment.

According to a second aspect of the present disclosure, a method of adjusting an environmental feature associated with an enclosed environment is provided. Output from receivers of the radar modules is received. The output is based on reflected radar signals within the enclosed environment as detected by the antennas. The processor(s) generate a preprocessed data set for each of the antennas. Movement(s) of the one or more objects within the enclosed environment is localized based on the preprocessed data sets. An environmental feature associated with the enclosed environment may be adjusted based on the localized movements.

According to a third aspect of the present disclosure, a system for adjusting an environmental feature associated with an enclosed environment is provided. The system includes a plurality of radar modules each including an antenna. The antennas are spaced apart at a different distance from one or more objects within the enclosed environment from which the radar signals are reflected. The antennas are configured to radiate radar signals into the enclosed environment, and collect radar signals reflected within the enclosed environment. One or more processors in electronic communication with the radar modules are configured to receive output from the radar modules. The output is based on reflected radar signals within the enclosed environment as detected by the antennas. The processor(s) generate a preprocessed data set for each of the antennas. The movements of the one or more objects within the enclosed environment may be localized. Presence of the one or more objects within the enclosed environment is determined based on the localized movements of the one or more objects within the enclosed environment. An environmental feature associated with the enclosed environment is adjusted based on the localized movements of the one or more objects within the enclosed environment.

In various implementations, the enclosed environment may be a vehicle cabin, and the environmental feature may be an infotainment system, vehicle controls, climate controls, safety features, or any combination thereof. A change in the radar signals detected by the antennas may be based on at least one of gross movements of the one or more vehicle occupants and breathing patterns of the one or more vehicle occupants.

In various implementations, the preprocessed data sets are range-Doppler plots. The methods may include generating the preprocessed data sets at different time slices for each of the plurality of antennas based on the radar signals collected by each of the plurality of antennas within a preset duration defining each of the different time slices. The time slice may be a period of time such as for period of time for microseconds, milliseconds, or the like. A function may be applied to the preprocessed data to determine a number of scalar values equal to a number of the different positions within the enclosed environment. Each of the scalar values may be a confidence score indicative of whether a respective one of the different positions is occupied. It may be determined that the confidence score for one of the scalar values exceeds a threshold. A respective one of the different positions may be classified as occupied if the scalar values exceeds the threshold.

In various implementations, the enclosed environment is a vehicle cabin. The localized movements are from one or more occupants within the vehicle cabin, and/or one or more doors being opened. Based on the localized movements of the one or more objects within the enclosed environment, the processor(s) may be configured to determine occupancy of the one or more seats within the enclosed environment, an opening of the one or more doors, or a combination thereof. A subsystem of the enclosed environment may be controlled based on the localized movement to adjust the environmental features. The subsystem may be an infotainment system, vehicle controls, climate controls, and/or safety features.

In various implementations, the present disclosure mitigates or eliminates the multi-path effect by processing, with a trained deep neural network, the preprocessed data sets groupwise to determine or classify the vehicle condition(s) by localizing movement within the vehicle cabin. Refined output data from convolutional and pooling layers are further processed in a linear layer that includes output neurons equal to vehicle conditions to be determined. A classifier layer may map the linear layer to scalar values equal to a number of the output neurons to provide a confidence score. A subsystem of the vehicle, such as an infotainment system, vehicle controls, climate controls, safety features, among others, may be controlled based on the determined vehicle conditions.

The method of localizing occupants within the vehicle cabin may be formulated as a classification problem. The trained deep neural network may output, for example, four or six classes corresponding to the four or six seats of vehicle, respectively. The classes may be used to determine an occupant classification of the vehicle. The occupant classification may be outputted in a continuous manner limited only by computing speed, or at predetermined intervals (e.g., microseconds, milliseconds, seconds, or the like). At each instance of the output, a detection module may process the data sets groupwise to determine any presence of the occupant(s) within the vehicle cabin. Further, at each instance of the output, the trained deep neural network may process the data sets to localize the seat from which movement is mostly likely originating. Each of the scalar value indicates the confidence score that the movement is originating from a particular seat.

In various implementations, the trained deep neural network may improve accuracy of the localization being determined by the detection module. The generated range-Doppler plot is provided to the trained deep neural network after logarithmic transformation. The trained deep neural network may include convolutional layers and pooling layers to produce refined output data. The refined output data is processed in a linear layer, and a classifier model (or layer) applies a function to map the linear layer. The output from the trained deep neural network may be processed by the detection module to generate output, for example, an occupant classification in which occupied seats are identified, a vehicle condition classification in which open doors are identified, or the like.

Therefore, according to a fourth aspect of the present disclosure, a method of localizing one or more occupants within a vehicle cabin is provided. The method includes receiving, at the one or more processors, output from receivers of the radar modules based on reflected radar signals within the enclosed environment as detected by the antennas. One or more processors generates a preprocessed data set for each of the antennas based on the detected radar signals. For example, the preprocessed data sets may be range-Doppler plots or range-velocity maps. Optionally, the processor(s) may process the output based on the radar signals for each of the antennas collected for a preset duration defining a time slice, and generate the preprocessed data sets at different time slices for each of the antennas.

The preprocessed data sets are provided to a trained deep neural network. The trained deep neural network processes the preprocessed data sets groupwise to classify whether vehicle seats within the vehicle cabin are occupied by localizing movement of the occupant(s) within the cabin. The trained deep neural network may assign a confidence score for each of a plurality of output neurons of the trained deep neural network. Each of the vehicle seats may be classified as occupied if the confidence score exceeds a threshold. Additionally or alternatively, an ArgMax function may be used for the classification. The method includes, optionally, adjusting an environmental feature of the vehicle based on an occupant classification of the vehicle seats. For example, the environmental feature may be displaying vehicle condition on an interface, reminding driver of a potential left-behind occupant, adjusting audio settings, or any combination thereof.

In certain implementations, a number of input channels of the trained deep neural network are equal to a number of the antennas. A number of the output neurons of the trained deep neural network are equal to a number of vehicle seats within the vehicle cabin. The preprocessed data sets may be processed by the trained deep neural network in a first convolutional layer having a number of output channels being a product of a number of the plurality of antennas, and a predetermined number of kernels. Output data from the first convolutional layer may be provided to a second convolutional layer of the trained deep neural network, and the second convolutional layer processes the output data. A number of output channels of the second convolutional layer may be a product of the number of output channels of the first convolutional layer, and the number of kernels. Thereafter, the trained deep neural network processes output data from the second convolutional layer with pooling layers and additional convolutional layers to produce refined output data. The additional convolutional layers and pooling layers may be organized in any suitable hierarchy, process, or arrangement. The refined output data is processed to a linear layer. In particular, the refined output data may be serialized, for example, a tensor flattened to a one-dimensional tensor of a predetermined length. The linear layer includes the output neurons. Lastly, a classifier layer applies a function to map the linear layer to a number of scalar values equal to the number of the output neurons. The scalar values may provide the confidence score indicative of whether a respective one of the vehicle seats is occupied, or satisfaction of another vehicle condition.

A fifth aspect of the present disclosure is directed to a method of determining a vehicle condition associated with a vehicle cabin. The vehicle condition may be whether vehicle seats are occupied, and/or whether vehicle doors are opened. The method includes receiving, at the one or more processors, output from receivers of the radar modules based on reflected radar signals within the enclosed environment as detected by the antennas. The data is provided to a trained deep neural network. The trained deep neural network processes the data in convolutional and pooling layers to produce refined output data. The refined output data is processed in a linear layer that includes a number of output neurons equal to a number of vehicle conditions to be determined. The trained deep neural network includes a classifier layer that applies a function to map the linear layer to a number of scalar values equal to the number of output neurons. The vehicle condition may be determined by localizing movement within the vehicle cabin based on the scalar values.

In certain implementations, the radar module preprocesses the data. The preprocessing of the data may include generating a range-Doppler plot or a range-velocity plot for each of the receivers. A number of input channels of the preprocessed data is equal to a number of the receivers. The trained deep neural network may assign a confidence score for each output neuron, and classify each of the vehicle conditions as satisfied if the confidence score exceeds a threshold.

A sixth aspect of the present disclosure is directed to a system for determining a vehicle condition associated with a vehicle cabin of a vehicle. The vehicle cabin includes vehicle seats and vehicle doors. The system includes a plurality of transmitters and a plurality of receivers. Each of the receivers includes an antenna. The transmitters and the receivers may be structurally or functionally integrated as transceivers. The antennas are disposed at different locations within the vehicle cabin and each being configured to transmit radar signals within the vehicle cabin. The antennas are spaced at different distances from one or more intended locations, for example, one or more objects moving within the vehicle cabin from which the radar signals are reflected. Each of the antennas are configured to detect radar signals corresponding to transmitted radar signals after being reflected within the vehicle cabin. One or more processors are in electronic communication with the transmitters and the receivers. The processor(s) are configured to receive output from each of the receivers, preprocess the output, and provide the preprocessed data sets to a trained deep neural network. The processing includes generating a preprocessed data set for each of the antennas. In certain implementations, the processor(s) are configured to preprocess the radar signals collected for a preset duration defining a time slice, and generate the preprocessed data sets for different time slices for each of the plurality of antennas. The trained deep neural network processes the preprocessed data sets groupwise to classify whether each of the vehicle seats within the vehicle cabin is occupied or whether each of the vehicle doors is opened. The groupwise processing of the data with the trained deep neural network achieves localization of even subtle movements by the occupant(s) despite the challenges associated with multi-path effect, thereby providing meaningful output generally at the limit of antenna specifications and capabilities.

### BRIEF DESCRIPTION OF THE DRAWINGS

FIG. 1 depicts an exemplary implementation of a system for determining vehicle conditions based on localizing movement within a vehicle cabin.

FIG. 2 depicts another exemplary implementation of the system for determining vehicle conditions based on localizing movement within a vehicle cabin.

FIG. 3 is an exemplary method for determining vehicle conditions based on localizing movement within the vehicle cabin.

FIG. 4 is an exemplary method for determining the vehicle conditions based on localizing the movement within the vehicle cabin, wherein steps or layers associated with a trained deep neural network are depicted.

FIG. 5 is an exemplary architecture of the trained deep neural network configured to perform the methods of FIG. 3 or 4.

FIG. 6 is an exemplary method of training the deep neural network.

FIG. 7 is a schematic representation of the system according to the present disclosure and configured to perform the methods disclosed herein.

### DETAILED DESCRIPTION

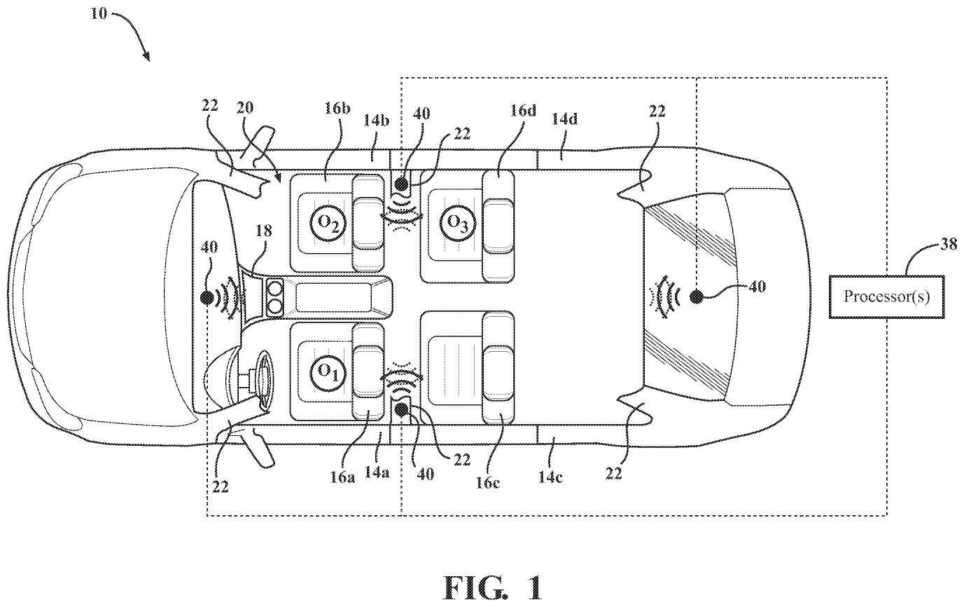

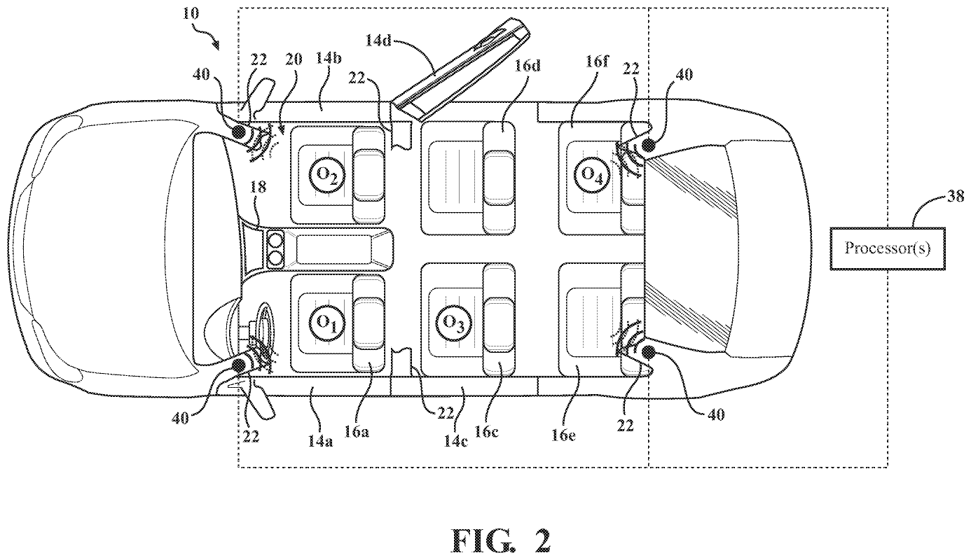

Referring to FIGS. 1 and 2, a vehicle 10 is shown to have doors 14a-14d, seats 16a-16f, the infotainment system 18, and three or more radar modules 40 mounted within a vehicle cabin 20 of the vehicle 10. The infotainment system 18 may include a communication interface. Vehicle 10 may also include subsystems other than the infotainment system 18, such as vehicle controls, one or more climate controls, and one or more safety features, not shown in FIGS. 1-2 for simplicity. In various aspects, a frame of the vehicle 10 may include front, side, and rear pillars 22 supporting a roof (not shown) to define the vehicle cabin 20. As shown in FIG. 1, the exemplary vehicle 10 has four doors, four seats, and four radar modules 40 mounted within the vehicle cabin 20 at different positions. A first radar module 40 is mounted approximately in the middle of a front console, second and third radar modules 40 are mounted approximately in the middle of side pillars 22 along the sides of the vehicle 10, and a fourth radar module 40 is mounted approximately in the middle of a rear console. The resulting cruciform arrangement generally provides coverage of the radar signals for the entire vehicle cabin 20. The radar modules 40 may be arranged at other intended locations to limit signal clutter and/or create a clear line of sight. For illustrative purposes, a first occupant (O1) is situated in the driver seat, a second occupant (O2) is situated in the passenger seat, and a third occupant (O3) is situated in the passenger rear seat. In manners to be described, implementing the systems and methods disclosed herein provide for determining the first seat 16a, the second seat 16b, or the fourth seat 16d are occupied.

FIG. 2 depicts another exemplary vehicle 10 having four doors, six seats, and four radar modules 40 mounted within the vehicle cabin 20 at different positions. The first and second radar modules 40 are mounted to the front pillars 22, and third and fourth radar modules 40 are mounted to the rear pillars 22, again resulting in a cruciform-type arrangement. A first occupant (O1) is situated in the driver seat, a second occupant (O2) is situated in the passenger seat, a third occupant (O3) is situated in the driver-side captain seat, and a fourth occupant (O4) is situated in the passenger rear seat. Moreover, the passenger rear door 14d is opened. Implementing the systems and methods disclosed herein provide for determining the first seat 16a, the second seat 16b, the third seat 16c, and the fifth seat 16f are occupied, and the fourth door 14d is opened.

It should be appreciated that the vehicle 10 may include more or less than four radar modules so long as there are at least three radar modules 40 within the vehicle cabin 20 for a multi-node configuration. For examples, there may be six, eight, or ten or more radar modules. Further, the radar modules 40 may be mounted at positions different from the positions within vehicles 10 as shown in FIGS. 1-2. The radar modules may be mounted at any suitable locations within the vehicle cabin 20 and in any suitable spatial arrangement to limit signal clutter, and/or create a clear line of sight for occupants.

In various implementations, each radar module 40 may include a transmitter, an antenna, a receiver, and one or more processors. The transmitter and antenna may be arranged within the radar module 40 to minimize internal return path leak. The radar module may include a radiofrequency (RF) transceiver that transmits radar signals and detects the transmitted radar signals after the radar signals being reflected within or about the vehicle cabin 20. Each of the radar modules 40 may include directional antennas oriented towards one or more intended locations within the vehicle cabin 20. The antennas radiate the radar signals inside the vehicle cabin 20.

The radar signals travel through the vehicle cabin 20 and interact with objects in their path. After the signals encounter objects present within the vehicle cabin 20 and get reflected back towards the radar module 40, the antenna collects the signals and provides them to the receiver of the radar module 40. The receiver may amplify the signal, and perform other signal conditioning. The processor(s) (or the receiver) may further process the reflected radar signals received from the antennas to extract information about the targets (i.e., any occupants present within the vehicle cabin 20), including their distance, motion, and other characteristics. The radar module 40 may be a Doppler radar system or other radar system that may measure velocity and motion of targets.

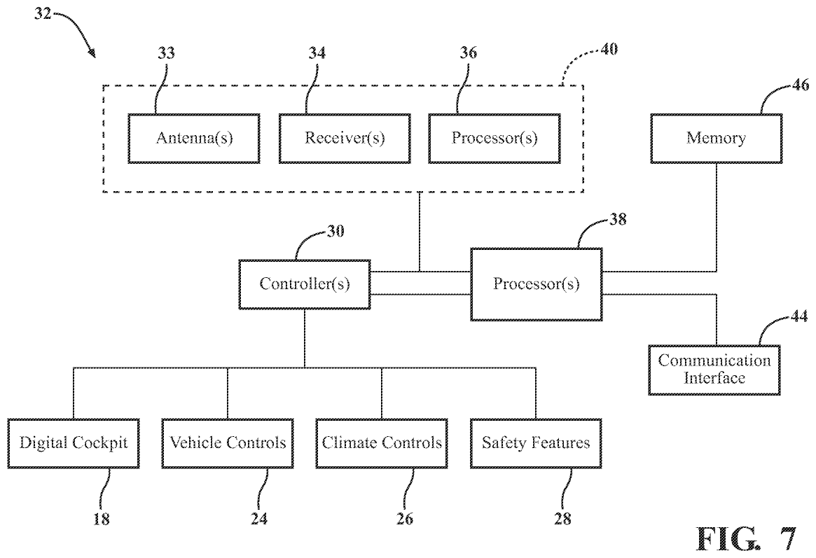

Vehicle 10 may include one or more processor(s) 38 in electronic communication with the radar modules 40 via the one or more processor(s) within each of the radar modules 40 (as represented by dashed lines in FIGS. 1 and 2). The processor(s) 38 may be, for example, an on-board vehicle computer. The processor(s) 36 within the radar modules 40 (as shown in FIG. 7) may operate the radar modules 40 to transmit short radar pulses and receive the reflected radar signal. In particular, the processor(s) 36 may transmit control signals to the radar modules 40 for the radar modules 40 to operate according to any suitable operating protocol or scheme. For example, the radar modules 40 may be operated in a continuous or near-continuous manner, or fixed, varied, or staggered intervals. The radar modules 40 may also be selectively activated singularly, in pairs or other suitable combination. The antennas of the radar modules 40 may collect the radar signals for a preset duration defining a time slice or sequence (e.g., a period of time for microseconds, milliseconds, or the like). The time slice may be a configurable to correspond appropriately for detection of vital signs such as respiratory rates.

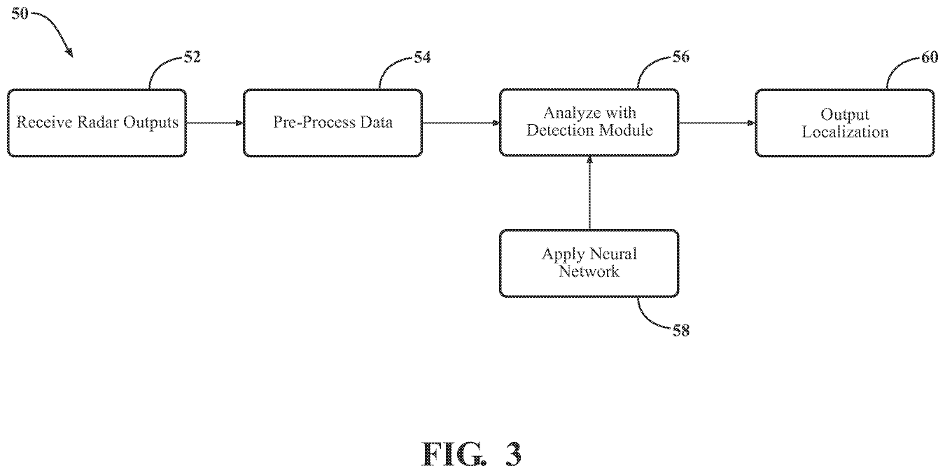

FIG. 3 depicts a method 50 of determining vehicle conditions within a vehicle cabin. Exemplary vehicle conditions include (i) whether and where one or more occupants are present within the vehicle cabin 20, and/or (ii) whether one or more of the doors 14a-14d of the vehicle is open. Additional vehicle conditions are contemplated, for example, information related to the occupant(s). The method 50 may be performed in a near-continuous or continuous manner such that minute deviations in the radar signals due to even subtle movements by the occupant(s) can be accurately localized and characterized. Vital signs such as respiration rates may be determined from a distance as large as one meter from a target using radar. Therefore, implementing the methods 50 disclosed herein provide for accurate and precise occupant classification, overcoming shortcomings in existing systems deployed in environments prone to multi-path effect and effects of clutter.

As shown in FIG. 3, the method 50 includes receiving the outputs from the receivers (step 52). The outputs may be based on electrical current at terminals of the antenna, following any amplification and processing by the receivers of the radar modules 40. The step 52 of receiving the outputs from the receivers 34 may be, in certain implementations, the first method step such that the method 50 may be entirely performed as computer-readable instructions stored on a non-transitory memory and configured to be executed by the processor(s) 36.

The method 50 includes the step of pre-processing data from the output of the receivers (step 54). The radar signals collected by each of the receivers may be normalized over a main tap of an internal return. In one example, employing a correlator, the collected radar signals are used to estimate a channel impulse response (CIR). Each radar module generates the estimated CIR for the time slices or sequences, and the estimated CIR is accumulated in an internal buffer over a fixed period for the antenna of each of the receivers being pointing at the intended location(s). Once the internal buffer is satisfied, a hardware-accelerated fast Fourier transform (FFT) is used over a set of the CIR sequences to generate the range-Doppler plots. The range-Doppler plots indicate an intensity of the reflected signal at each range and velocity. The step 54 may be performed for each time slice. Therefore, the processor 36 may generate the preprocessed data sets at different time slices for each of the receivers 34.

The method 50 includes analyzing with a detection module the preprocessed data sets (step 56). In particular, the generated range-Doppler plots from step 54 are provided to the detection module. The detection module outputs a presence condition, that is whether there are any occupants within the vehicle cabin 20. In other words, the detection module searches for a sign of human breathing in real-time in a set of the received range-Doppler plots. A logarithmic likelihood of variance of the signal is calculated at different taps, and the likelihood values are calibrated over different locations. Further, based on generalized likelihood ratio test on a subset of corresponding seat locations, the detection module may determine whether and where within the vehicle cabin 20 an occupant is present.

The step 56 may include applying a neural network (step 58) in which the receivers 34 is processed groupwise to localize movements. As used herein, “groupwise” may mean as a group, all, codependently, simultaneously, collectively, or the like. The number of input channels of the trained deep neural network may be equal to the number of receivers. The trained deep neural network processes the range-Doppler plots groupwise to determine or categorize the vehicle condition by localizing where within the vehicle cabin 20 movements happen. The trained deep neural network may extract features and/or patterns within the range-Doppler plots. The features or patterns may be used to predict the location of the occupants and to classify the movements of the occupants based on movement categories. One category is defined based on the vibration model of human breathing (i.e., a micro-Doppler signature). Another category is defined based on human gestures to characterize gross movements from the range-Doppler plots. From the movement categories, the processor(s) 38 may determine the vehicle condition, such as an occupied seat, a door being open, or the like.

In various implementations, the trained deep neural network may verify whether seats 16 are actually occupied, and/or whether one or more doors 14 of the vehicle 20 are open. The method 50 includes outputting the localization (step 60) for further processing by the detection model or another processor to determine the vehicle condition(s). Based on the vehicle condition classification, the controller(s) 30 of the vehicle 10 may control the subsystems, including the infotainment system 18, one or more vehicle controls, one or more climate controls, and one or more safety features to adjust one or more environmental features of the vehicle 10 in manners to be further described.

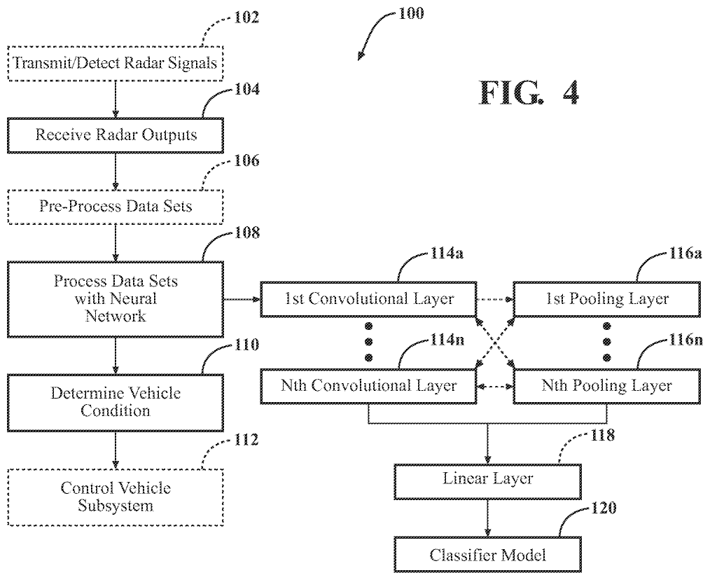

FIG. 4 shows a method 100 for determining a vehicle condition in which the steps or layers pertaining to a trained deep neural network are identified. The method 100 includes transmitting and detecting the radar signals (step 102), and in particular detecting the transmitted radar signals after being reflected about or within the vehicle cabin 20. Step 102 is optional, and in various implementations the method 100 may start at step 104 in which the radar outputs are received (step 104).

The method 100 may include receiving the outputs from the receivers (step 104) and data pre-processing (step 106). For example, as discussed, the outputs may be range-velocity data, and the step 106 may include generating range-Doppler plots for different time slices of output from each of the receivers. Steps 104 and 106 may be the same or similar to step 52 and step 54, respectively, of the method 50 as described above. It is contemplated that the step 106 may be optional, and the deep neural network may be configured and trained to process the range-velocity data directly from the receivers.

The generated range-Doppler plot is provided to the trained deep neural network in logarithmic transformation. The method 100 includes processing the data sets of collected radar signals reflected from any occupants within the vehicle cabin 20 with a trained deep neural network (step 108). In an exemplary implementation, the data sets are processed groupwise. The method 100 includes processing the data in convolutional layers (steps 114a-114n) and pooling layers (steps 116a-116n) to produce refined output data. The refined output data is processed in a linear layer (step 118), and a classifier model (or layer) applies a function to map the linear layer (step 120).

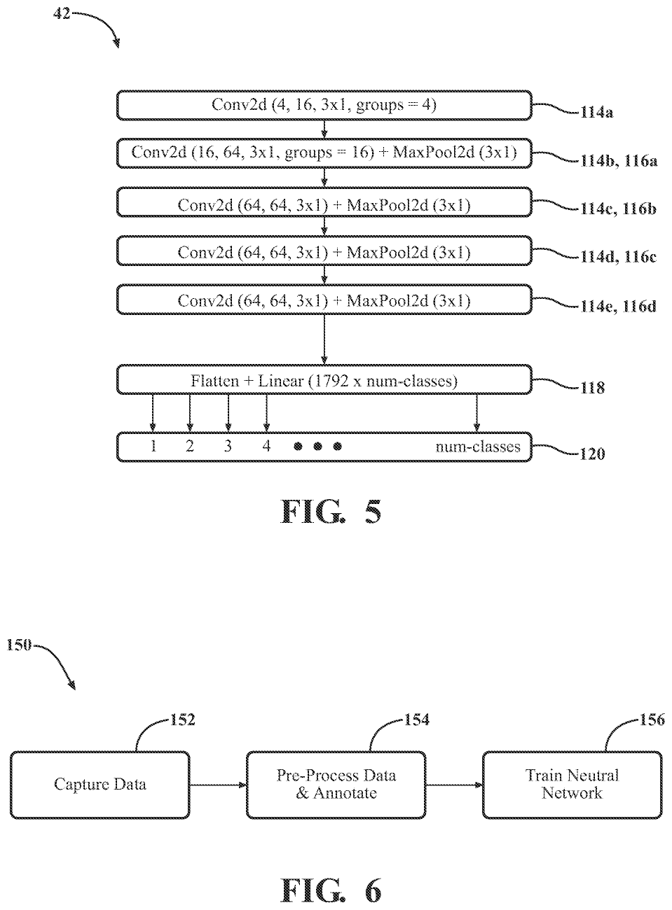

FIG. 5 schematically represents exemplary architecture of a deep neural network 42. The deep neural network 42 may include five convolutional layers 114a-114c, in which four of the five convolutional layers 114b-114e include pooling layers 116a-116d, the linear layer 118, and the classifier model 120 to be described in further detail. The deep neural network 42 is trained, and FIG. 6 depicts a method 150 of training the deep neural network 42. As shown in FIG. 6, a diverse and representative set of training dataset is captured (step 152) to train each of the neural networks on diverse scenarios both within and outside of expected uses of the vehicle 10. The method 150 includes preprocessing the data and annotation (step 154). For example, the deep neural network 42 may be trained offline on preprocessed raw data based on output from the receivers 34. The preprocessed data may be the range-Doppler plots previously described. The training data includes output associated with the receivers 34 from radar signals reflected from each of two, four, or six or more seats 16 in occupied and unoccupied states, and from each of the two, four, five, or six or more doors 14 in open and closed states. The deep neural network is trained for iterative test runs each including a generated association between test radar signals and/or range-Doppler plots, and data annotations indicative of whether the vehicle condition(s) are satisfied. In other words, for example, seat occupancy is known at the time of the test runs, and the seat occupancy is inputted to the system in a manner corresponding to the radar signature associated with the test run. The training data include an empirically measured a noise floor of the radar module in absence of any movements. The neural network(s) may execute algorithms trained using supervised, unsupervised, and/or semi-supervised learning methodology. Additional or alternative training methods may include data augmentation, previously trained neural networks, and/or use semi-supervised learning methodology.

Referring again to FIG. 5, in a non-limiting example of the architecture of the trained deep neural network 42, an input tensor has a dimension of 4×256×28, wherein 4 is the number of receivers, 256 is the number of Fast Fourier Transform bins for negative and positive velocities, and 28 is the number of range bins. In other words, input channels of the trained deep neural network 42 (e.g., the range-Doppler plots forming the preprocessed data sets) is equal to a number of the receivers.

First, a two-dimensional, first convolutional layer 114a may have a kernel of dimension 3×1. The preprocessed data sets are processed groupwise in the first convolutional layer 114a. The first convolution layer 114a may perform standard convolution or inner product by dividing the 4×256×28 into multiple 4×3×1 patches, and performing inner product of the kernels with the patches to obtain one output channel. The convolutions are performed with sixteen distinct kernels to create sixteen different output channels. As a result, the output from each receiver may be processed to account for the same spatial location pointing to different distances from each of the receivers. In the present example with four receivers, the output from each of the receivers is convolved with a predetermined number of kernels, four in this example, resulting in four of the sixteen output channels.

The output data from first convolutional layer 114a is processed with a two-dimensional, second convolutional layer 114b. In particular, the output data from the sixteen channels is passed to the second convolutional layer 114b having sixty-four output channels. The sixty-four output channels are based on each of the sixteen input channels (i.e., the sixteen output channels of the first convolutional layer 114a) being processed by four different kernels. Therefore, the number of output channels of the second convolutional layer 114b may be a product of the number of output channels of the first convolutional layer 114a and a predetermined number of kernels.

The method 100 includes processing, with the trained deep neural network, the output data from the second convolutional layer 114b, with pooling layers 116a-116n and additional convolutional layers 114c-114n to produce refined output data. For example, a first pooling layer 116a (e.g., MaxPool2d) with a kernel 3×1 outputs into 64×3×1 patches and outputs the maximum value in the patch. In the example architecture, a subsequent three layers of the trained deep neural network are two-dimensional convolutional layers 114 (without grouping) each followed by a pooling layer 116. The pooling layers 116 perform spatial dimension reduction to minimize numbers of parameters and computations for the next of the convolutional layers 114. The result is refined output data having a smaller spatial output but with sixty-four channels.

The method 100 may include serializing the refined output data in the linear layer (step 118). In certain implementations, the entire tensor is flattened to a one-dimensional tensor of a predetermined length. The predetermined length may be a product of the output channels of the last layer of the neural network, and the number of range bins. The number of range bins may be preserved throughout the different layers. Therefore, in various implementations, the predetermined length may be 1792; e.g., a product of the sixty-four output channels and the 28 range bins. The linear layer has a number of output neurons that is equal to a number of vehicle conditions for localization. If the vehicle condition to be determined is seat occupancy, the number of output neurons is equal to a number of seats 16 in the vehicle cabin 20. If the vehicle condition to be determined is a door status, the number of output neurons is equal to a number of the doors 14 in the vehicle 10.

The classifier model 120 applies a function that maps the length of the linear layer 118 to a number of scalar values equal to the number of output neurons. Each of the scalar values is or represents a confidence score indicative of whether a respective one of the vehicle conditions is satisfied (e.g., whether a respective one of the seats 16 is occupied). In other words, a localizer of the classifier model 120 may assign the confidence score for each of the output neurons of the trained deep neural network 42. The confidence score may be compared against a threshold. If the confidence score exceeds the threshold, the classifier model 120 may classify, for example, the respective one of the seats 16 as occupied based on the localized movement within the vehicle cabin 20. Alternatively, the localizer of the classifier model 120 may apply an ArgMax function to classify the seat(s) 16 as occupied based on the localized movement within the vehicle cabin 20. In this way, the output from the trained deep neural network 42 may be processed by the detection module (step 56) to generate output, for example, an occupant classification in which occupied seats are identified, a vehicle condition classification in which open doors are identified, or the like.

Both methods 50 and 100 disclosed herein may be executed and outputted in a real-time continuous or near-continuous manner. At every instant that the methods 50, 100 are being executed, any movements of occupants in the vehicle are being monitored, and classifications therefrom updated as necessary. In effect, this provides a real-time monitoring of the vehicle cabin 20 in an accurate and precise manner while overcoming the issue of multi-path effect. In other words, despite the presence of multi-path effect in the vehicle cabin 20, the trained deep neural network 42 may process the data to accurately localize movement as subtle as respiration. With the real-time monitoring of the vehicle cabin 20, any one or more of the environmental features of the vehicle 10 may be controlled and adjusted. For example, information reflecting the vehicle condition may be displayed on a communication interface of the infotainment system 18 via the controller(s) of the vehicle 10. For another example, should the trained deep neural network 42 localizes movements associated with respiratory patterns to a rear seat (e.g., Occupant O5 of FIG. 2) and the vehicle is turned off, the infotainment system 18 may provide a notification or alert to remind the driver of the occupant, for example a potential child, in the rear of the vehicle cabin 20. For another example, should the trained deep neural network 42 localizes a set of gross movements to a passenger seat and a rear seat (e.g., Occupants O2 and O4 of FIG. 1), the infotainment system 18 may adjust audio settings of the vehicle 10 to enhance acoustics for all occupants present within the vehicle cabin 20.

Still further, the occupant classification may include providing information about physiological status of one or more occupants. As a change in the detected radar signals may be associated with changes in breathing patterns, among other things, the occupant classification may provide clues that the one or more occupants may be anxious, drowsy, incapacitated, or the like. Such determinations may be based on previously compiled physiologic data for humans, and/or the deep neural network may be further trained to the physiologic data of the occupant(s) to identify deviations therefrom. The training data may be from a singular instance of travel of the vehicle (e.g., the passenger upon entry of the vehicle), or over a longer timeframe (e.g., the driver over several instances of travel). The physiologic data may be combined with vehicle movement data and/or driving conditions (e.g., precipitation, terrain, etc.), before being collected, compiled, and analyzed accordingly. The combined data may be further used to train the deep neural network, from which the trained deep neural network may be configured to anticipate changes in vehicle movement data or driving conditions based on changes in physiologic data, or vice versa. The compiled data may also be used to identify driver population trends, unsafe road locations, and the like.

Additionally or alternatively, the controller(s) 30 may adjust the vehicle controls 24, and ameliorative action may be taken responsively by the vehicle 10, and/or notifications may be provided to the occupant(s). For example, the infotainment system 18 may suggest a “traction mode” if it is determined the driver may be anxious and there is a likelihood of snow. It is readily appreciated that a variety of climate controls 26 and configurations may be implemented based on the occupant classification. For example, the air condition may be adjusted based on the number of occupants within the vehicle cabin 20. The safety features 28 may include generating seatbelt warnings based on the occupant classification, drowsiness alerts based on the occupant information, door warnings based on door classification, and the like. Another example includes the infotainment system 18 being configured for “gesture control” in which movements of the driver may be localized and determined according to the methods 50, 100 disclosed herein, after which the infotainment system 18, vehicle controls 24, climate controls 26, and safety features 28 may be correspondingly operated.

Therefore, the systems and methods disclosed herein may be readily implemented on a variety of different sizes, shapes, and in-cabin features associated of existing vehicle models that are equipped with radars. The deep neural network may be trained by receiving data sets of detected radar signals under varying vehicle conditions for a given vehicle model. As the detected radar signals are reflected at least in part on the characteristics of the vehicle itself (e.g., chassis or paneling of the vehicle), the data sets may be vehicle model-specific. As such, the trained neural network may be deployed on existing vehicles by providing non-transitory computer instructions stored on memory 46 and configured to be executed by one or more processors of the vehicle, or via remote processing. For example, over-the-air software updates may be sent in the form of one or more push notifications to a communication interface 44 of the infotainment system 18 for the vehicle to be capable of performing the methods as described and disclosed herein. Among other advantages, enabling features with an over-the-air software update facilitates retrofitting or upgrading existing vehicle models with relative case for improved user enjoyment, comfort, and/or safety.

Moreover, the systems and methods disclosed herein may be readily implemented on a variety of future vehicle models, thereby reducing design and manufacturing costs often associated with the model-specific hardware configurations. For example, for each future vehicle model having a substantially different antenna arrangement within the cabin, the deep neural network may be correspondingly trained and deployed. Additionally or alternatively, the trained deep neural network may be sufficiently accurate and precise across multiple existing or future vehicle models, or a fleet of existing or future vehicle models.

More generally, it is contemplated that the methods disclosed herein may be used in other semi-enclosed or enclosed environments in which radar signals may be transmitted, reflected, collected, and processed. A non-limiting example of such an application includes an office space in which one or more occupants may be generally associated with predefined locations (e.g., a plurality of workstations). The occupancy of the predefined locations may be the condition to be determined, and the deep neural network may be trained and deployed to localize the occupant(s) within the office and control in-office lighting, air conditioning, electronics, and other amenities based on where within the office the occupant(s) are present.

The system 32 for performing the methods 50, 100 disclosed herein to localize presence of any occupants and to adjust environmental features associated with the vehicle 10 is shown in FIG. 7. The system 32 includes one or more controller(s) 30, and subsystems of the vehicle 10 including the infotainment system 18, vehicle controls 24, climate controls 26, and safety features 28 in electronic communication with the vehicle controller(s) 30. The processor(s) 38 are in electronic communication with the controller(s) 30 and configured to transmit control signals to the controller(s) 30 based on output from the methods 50, 100. The controller(s) 30 are configured to operate the infotainment system 18, vehicle controls 24, climate controls 26, and safety features 28, or combination thereof, to control or adjust one or more environmental features of the vehicle 10, such as displaying vehicle condition on an interface, reminding driver of a potential left-behind occupant, or adjusting audio settings as described above. Alternatively, the processor(s) 38 and the controller(s) 30 may be electronically integrated.

The system 32 includes the radar modules 40 configured to transmit short radar pulses and receive the reflected signal. The radar modules 40 may include a transmitter, an antenna 33, a receiver 34, and one or more processors 36. In various implementations, the receiver 34 and the processor(s) 36 may be electronically integrated. The transmitter and the antenna 33 may be arranged within the radar module 40 to minimize internal return path leak. The radar module 40 may be a radiofrequency (RF) transceiver that transmits radar signals and detects the transmitted radar signals after the radar signals being reflected within or about the vehicle cabin 20 The radar modules 40 may include tunable and directional antennas (A) configured to form beams that are steered or unsteered, wide, narrow, or shaped (e.g., hemisphere, cube, fan, cone, cylinder). The radar modules 40 may support continuous-wave or pulsed radar operations. Components of the radar module 40 may further include amplifiers, mixers, switches, analog-to-digital converters, filters, or logic for conditioning and/or modulating the radar signals through any suitable modulation.

The radar modules 40 may be configured to process the data at a bandwidth higher than 500 Megahertz (MHz) with high sensitivity at low signal to noise (SNR) ratios. A frequency spectrum may encompass frequencies between 1 and 10 Gigahertz (GHz), and more particularly between approximately 5 and 9 GHz. The frequency spectrum can be divided into multiple sub-spectrums that have similar or different bandwidths. The radar may be an ultra-wideband radar sharing a local oscillator between the front-end receiver and front-end transmitter circuits. A known preamble may modulate carrier frequency to be transmitted over the antenna. The received signal may be down-converted based on the frequency of the local oscillator at the front-end transmitter, and sampled at an analogue-to-digital converter (ADC). For example, in the preamble process configuration, the preamble may be chosen according to IEEE Standard 802.15.4.

The radar modules 40 are in electronic communication with the processor(s) 38, and optionally with the vehicle controller(s) 30. As a result, the method 50, 100 and one or more of its steps disclosed herein are configured to be executed by the processor(s) 38 according to instructions stored on the non-transitory memory 46 or other non-transitory computer readable medium, such as RAM, ROM, flash memory, EEPROM, optical devices, hard drives, floppy drives, or the like. The computer-executable instructions may be implemented using an application, applet, host, server, network, website, communication service, hardware, firmware, software, or the like. The data may be analyzed by the processor 38 of the vehicle, and/or the data may be transmitted for remote processing (e.g., cloud computing).

Various implementations of the present disclosure are described with reference to the following exemplary clauses:

Clause 1—A method of localizing one or more occupants within a vehicle cabin with a system including a plurality of antennas located at different positions within the vehicle cabin, and one or more processors, the method comprising: detecting, with each of the plurality of antennas, radar signals corresponding to transmitted radar signals after being reflected within the vehicle cabin; generating, at the one or more processors, a preprocessed data set for each of the plurality of antennas; and providing the preprocessed data sets to a detection module in which a trained deep neural network processes the preprocessed data sets groupwise to determine which vehicle seats within the vehicle cabin are occupied by localizing movement of the one or more occupants within the vehicle cabin.

Clause 2—The method of claim 1, further comprising: assigning, with the trained deep neural network, a confidence score for each of a plurality of output neurons of the trained deep neural network; and classifying, with the trained deep neural network, one or more of the vehicle seats as occupied if a respective one or more of the confidence scores exceed a threshold.

Clause 3—The method of clause 2, wherein a number of input channels of the trained deep neural network are equal to a number of the plurality of antennas, and wherein a number of the output neurons of the trained deep neural network is equal to a number of vehicle seats within the vehicle cabin.

Clause 4—The method of clause 3, further comprising processing, with the trained deep neural network, the preprocessed data sets in a first convolutional layer having a number of output channels being a product of a number of the plurality of antennas and a predetermined number of kernels.

Clause 5—The method of clause 4, further comprising processing, with the trained deep neural network, output data from the first convolutional layer in a second convolutional layer having a number of output channels being a product of the number of output channels of the first convolutional layer and the predetermined number of kernels.

Clause 6—The method of clause 5, further comprising: processing, with the trained deep neural network, output data from the second convolutional layer with pooling layers and additional convolutional layers to produce refined output data; serializing the refined output data; and processing, with the trained deep neural network, the serialized data in a linear layer that includes the output neurons.

Clause 7—The method of clause 6, further comprising processing, with the trained deep neural network, the linear layer with a classifier model that applies a function to map the linear layer to a number of scalar values equal to the number of the output neurons.

Clause 8—The method of clause 7, wherein each of the scalar values is a confidence score indicative of whether a respective one of the vehicle seats is occupied.

Clause 9—The method of clause 1, wherein a change in the detected radar signals are based on at least one of gross movement of the one or more occupants, breathing of the one or more occupants, and cardiac activity of the one or more occupants.

Clause 10—The method of clause 1, further comprising: processing, with the one or more processors, the radar signals for each of the plurality of antennas collected for a preset duration defining a time slice; and generating, at the one or more processors, the preprocessed data sets at different time slices for each of the plurality of antennas.

Clause 11—The method of clause 1, further comprising controlling, with the one or more processors or a vehicle controller, an environmental feature of the vehicle based on an occupant classification of whether the vehicle seats within the vehicle cabin are occupied, wherein the environmental feature is selected from the group consisting of an infotainment system, vehicle controls, climate controls, and safety features.

Clause 12—The method of clause 1, wherein the preprocessed data sets are range-Doppler plots.

Clause 13—A method of determining a vehicle condition associated with a vehicle cabin with a system including a plurality of antennas located at different positions within the vehicle cabin, and one or more processors, the method comprising: detecting, with each of the plurality of antennas, radar signals corresponding to transmitted radar signals after being reflected within the vehicle cabin; and providing data to a detection model in which a trained deep neural network performs steps comprising: processing the data in convolutional and pooling layers to produce refined output data; processing the refined output data in a linear layer that includes a number of output neurons equal to a number of vehicle conditions to be determined; applying a function with a classifier model to map the linear layer to a number of scalar values equal to the number of output neurons; and determining the vehicle condition by localizing movement within the vehicle cabin based on the scalar values.

Clause 14—The method of clause 13, wherein the steps performed by the trained deep neural network further comprises: assigning a confidence score for each output neuron of the trained deep neural network; and classifying one or more of the vehicle conditions as being satisfied if a respective one or more of the confidence scores exceed a threshold.

Clause 15—The method of clause 13, further comprising preprocessing the data by generating a range-velocity plot or a range-Doppler plot for each of input channels of the trained deep neural network.

Clause 16—The method of clause 15, wherein a number of the input channels of the preprocessed data equal to a number of the plurality of antennas.

Clause 17—The method of clause 13, wherein the vehicle condition is of one of whether vehicle seats are occupied, and whether vehicle doors are opened.

Clause 18—A system for determining a vehicle condition associated with a vehicle cabin of a vehicle including vehicle seats and vehicle doors, the system comprising: a plurality of radar modules each including an antenna disposed within the enclosed environment and each configured to radiate radar signals into the enclosed environment and collect radar signals reflected within the enclosed environment, wherein each of the antennas are spaced apart at a different distance from one or more objects within the enclosed environment from which the radar signals are reflected; and one or more processors in electronic communication with the plurality of radar modules, wherein the one or more processors are configured to: receive, at the one or more processors, output from a receiver of each of the plurality of radar modules based on reflected radar signals within the enclosed environment as detected by the plurality of antennas; generate, at the one or more processors, a preprocessed data set for each of the plurality of antennas; and provide the preprocessed data sets to a detection module in which a trained deep neural network processes the preprocessed data sets groupwise to determine whether each of the vehicle seats within the vehicle cabin is occupied or whether each of the vehicle doors is opened by localizing movement of the one or more objects within the vehicle cabin.

Clause 19—The system of clause 18, wherein the plurality of receivers are mounted to the vehicle at fixed locations comprising a front console, a rear console, front pillars, side pillars, or rear pillars.

Clause 20—The system of clause 18, wherein the one or more processors are further configured to preprocess the radar signals collected for a preset duration defining a time slice, and generate the preprocessed data sets for different time slices for each of the plurality of receivers.

Clause 21—A method of localizing one or more objects with an enclosed environment including a plurality of antennas located at different positions, and one or more processors, the method comprising: detecting, with each of the plurality of antennas, radar signals corresponding to transmitted radar signals after being reflected by the one or more objects; generating, at the one or more processors, a preprocessed data set for each of the plurality of antennas; and providing the preprocessed data sets to a detection module in which a trained deep neural network processes the preprocessed data sets groupwise to localize movement of the one or more objects within the enclosed environment.

Clause 22—A method of localizing one or more objects with an enclosed environment including a plurality of antennas located at different positions, and one or more processors, the method comprising: detecting, with each of the plurality of antennas, radar signals corresponding to transmitted radar signals after being reflected by the one or more objects; and providing data to a detection model in which a trained deep neural network performs steps comprising: processing the data in convolutional and pooling layers to produce refined output data; processing the refined output data in a linear layer that includes a number of output neurons equal to a number of conditions to be determined; applying a function with a classifier model to map the linear layer to a number of scalar values equal to the number of output neurons; and determining the conditions by localizing movement based on the scalar values.

Clause 23—A system for adjusting an environmental feature associated with an enclosed environment, the system comprising: a plurality of radar modules each including an antenna disposed within the enclosed environment and each configured to radiate radar signals into the enclosed environment and collect radar signals reflected within the enclosed environment, wherein each of the antennas are spaced apart at a different distance from one or more objects within the enclosed environment from which the radar signals are reflected; and one or more processors in electronic communication with the plurality of radar modules, wherein the one or more processors are configured to: receive, at the one or more processors, output from a receiver of each of the plurality of radar modules based on reflected radar signals within the enclosed environment as detected by the plurality of antennas; generate, at the one or more processors, a preprocessed data set for each of the plurality of antennas; and provide the preprocessed data sets to a detection module in which a trained deep neural network processes the preprocessed data sets groupwise to localize movement of the one or more objects within the enclosed environment.

The foregoing disclosure is not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

1. A method of localizing one or more objects within an enclosed environment with radar modules including a plurality of antennas pointed at different positions within the enclosed environment, the method comprising:
receiving output from receivers of the radar modules based on reflected radar signals within the enclosed environment as detected by the plurality of antennas;
generating a preprocessed data set for each of the plurality of antennas;
localizing movements of the one or more objects within the enclosed environment based on the preprocessed data sets for the plurality of antennas; and
determining occupancy of the one or more objects at the different positions based on the localized movements of the one or more objects within the enclosed environment.

2. The method of claim 1, further comprising adjusting an environmental feature of the enclosed environment based on the determined occupancy.

3. The method of claim 2, wherein the enclosed environment is a vehicle cabin including one or more subsystems, and wherein the one or more subsystems include an infotainment system, vehicle controls, climate controls, safety features, or any combination thereof.

4. The method of claim 1, further comprising classifying a movement category for each of the one or more objects based on the localized movements, wherein the movement category is one of gross movements of the one or more objects and breathing patterns of the one or more objects.

5. The method of claim 1, further comprising generating the preprocessed data sets at different time slices for each of the plurality of antennas based on the radar signals collected by each of the plurality of antennas within a preset duration defining each of the different time slices.

6. The method of claim 1, wherein the preprocessed data sets are range-Doppler plots.

7. The method of claim 1, further comprising applying a function to the preprocessed data to determine a number of scalar values equal to a number of the different positions within the enclosed environment.

8. The method of claim 7, wherein each of the scalar values is a confidence score indicative of whether a respective one of the different positions is occupied, the method further comprising:
determining the confidence score for one of the scalar values exceeds a threshold; and
classifying a respective one of the different positions as occupied.

9. The method of claim 1, wherein the step of localizing the movement is performed by a trained deep neural network, wherein a number of input channels of the trained deep neural network is equal to a number of the plurality of antennas.

10. The method of claim 9, wherein a number of output neurons of the trained deep neural network is equal to a number of the different positions within the enclosed environment.

11. The method of claim 9, wherein the trained deep neural network includes convolutional layers, pooling layers, a linear layer, and a classifier model, the method further comprising:
producing, via the convolutional layers and the pooling layers, refined output data based on the preprocessed data sets;
serializing the refined output data to a linear layer that includes a number of output neurons equal to a number of conditions of the enclosed environment to be determined;
applying a function with a classifier model to map the linear layer to a number of scalar values equal to a number of output neurons; and
localizing movements within the enclosed environment based on the scalar values.

12. A method of adjusting an environmental feature associated with an enclosed environment with radar modules including a plurality of antennas located at different positions within the enclosed environment, the method comprising:
receiving output from receivers of the radar modules based on reflected radar signals within the enclosed environment as detected by the plurality of antennas;
generating a preprocessed data set for each of the plurality of antennas;
localizing movements of one or more objects within the enclosed environment based on the preprocessed data sets; and
adjusting the environmental feature associated with the enclosed environment based on the localized movements.

13. The method of claim 12, wherein the enclosed environment is a vehicle cabin, and wherein the localized movements are from one or more occupants within the vehicle cabin, or one or more doors being opened.

14. The method of claim 12, wherein the one or more objects are one or more vehicle occupants, and wherein a change in the radar signals detected by the plurality of antennas is based on at least one of gross movements of the one or more vehicle occupants and breathing patterns of the one or more vehicle occupants.

15. The method of claim 14, wherein the environmental feature includes an infotainment system, vehicle controls, climate controls, safety features, or any combination thereof.

16. The method of claim 12, further comprising generating the preprocessed data sets at different time slices for each of the plurality of antennas based on the radar signals collected by each of the plurality of antennas within a preset duration defining each of the different time slices.

17. The method of claim 12, wherein the preprocessed data sets are range-Doppler plots.

18. A system for adjusting an environmental feature associated with an enclosed environment, the system comprising:
a plurality of radar modules each including an antenna disposed within the enclosed environment and each configured to radiate radar signals into the enclosed environment and collect radar signals reflected within the enclosed environment, wherein each of the antennas are spaced apart at a different distance from one or more objects within the enclosed environment from which the radar signals are reflected; and
one or more processors in electronic communication with the plurality of radar modules, wherein the one or more processors are configured to:
receive, at the one or more processors, output from a receiver of each of the plurality of radar modules based on reflected radar signals within the enclosed environment as detected by the antennas;
generate, at the one or more processors, a preprocessed data set for each of the antennas;
localize movements of the one or more objects within the enclosed environment;
determine presence of the one or more objects within the enclosed environment based on the localized movements of the one or more objects within the enclosed environment; and
adjust the environmental feature associated with the enclosed environment based on the localized movements of the one or more objects within the enclosed environment.

19. The system of claim 18, wherein the radar modules are mounted in the enclosed environment in a cruciform arrangement.

20. The system of claim 18, wherein the enclosed environment is a vehicle cabin including one or more subsystems, and wherein the one or more subsystems include an infotainment system, vehicle controls, climate controls, safety features, or any combination thereof.
